(19) United States
(12) Patent Application Publication
(10) Pub. No.: US 2024/0010024 A1
(43) Pub. Date: Jan. 11, 2024

(54) Disposable Paint Tray Liner Device

(71) Applicant: Anthony Berg, Byron, IL (US)

(72) Inventor: Anthony Berg, Byron, IL (US)

(21) Appl. No.: 18/325,560

(22) Filed: May 30, 2023

Related U.S. Application Data
(60) Provisional application No. 63/359,434, filed on Jul. 8, 2022.

(51) Int. Cl. B44D 3/12

(52) U.S. Cl. CPC B44D 3/126

(57) ABSTRACT

A disposable paint tray liner device is disclosed that is a single use, plastic liner for paint trays. The disposable paint tray liner device comprises a body component that is a liner comprised of plastic material. The body component comprises an elastic band integrated around the body component perimeter. The elastic band can be used to secure the body component tightly to a paint tray. Users can fill the paint tray with paint while covered with the body component, preventing any paint from staining the paint tray itself. Once finished painting, the disposable paint tray liner device is removed and thrown away, leaving users with a clean paint tray.

### CROSS-REFERENCE TO RELATED APPLICATION

The present application claims priority to, and the benefit of, U.S. Provisional Application No. 63/359,434, which was filed on Jul. 8, 2022, and is incorporated herein by reference in its entirety.

### FIELD OF THE INVENTION

The present invention relates generally to the field of disposable paint tray liner devices. More specifically, the present invention relates to a disposable paint tray liner capable of preventing wet paint from staining the tray and requiring cleaning. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in disposable paint tray liner devices. Generally, people often use paint trays to store paint when using paint rollers, making it very easy to coat the roller pad in wet paint for application to a wall or other surface. However, constantly cleaning out the paint tray once finished can be time consuming and frustrating. Further, heavy plastic liners, which are currently available for the paint tray, are expensive to purchase and replace.

Various types of paint containers are used for holding, storing, and disposing of paint. When applying paint with a roller, a paint tray is used for holding the paint since it allows the user to evenly coat the roller. Paint trays are typically rectangular and shallow with a deep well at one end and an inclined portion leading into the well. The well holds the paint and the user dips the roller into the well to apply paint to the roller. The roller is then rolled out over the inclined portion to more uniformly distribute the paint to the roller. Paint that is not coated onto the roller travels downward along the inclined portion back into the well. Once painting is complete, the paint tray must be cleaned to remove the unused paint. It is important that all the paint be removed from the paint tray since any remnant paint could ruin the next paint placed in the paint tray. Depending on the type of paint used, the paint tray is typically cleaned with either water or paint thinner. Cleaning a paint tray, however, can be messy and difficult to achieve due in part to the ridges that are found in most commercial paint trays.

To facilitate paint tray cleanup, molded disposable paint tray liners have been developed that fit into the rigid paint trays. While this solution allows reuse of the rigid paint trays, these thin, plastic-molded tray liners often do not fit well into the rigid paint trays. Moreover, the pre-formed shape of the liners often gets bent and twisted when trying to fit the liner into a rigid paint tray. The bends can allow paint to leak into the rigid paint tray or make removing excess paint from the paint roller more difficult. Further, the molded pre-formed design of these paint tray liners can be costly to produce and can be prohibitively expensive to use for single use purposes. As a result, attempts are commonly made by users to clean and reuse the paint tray liners for multiple use before disposal, thereby, defeating the purpose of using a paint tray liner.

Accordingly, there is a demand for a disposable paint tray liner that prevents paint from staining a paint tray. More particularly, there is a demand for a disposable paint tray liner that, once finished painting, can be removed and thrown away to leave users with a clean paint tray.

Therefore, there exists a long-felt need in the art for a disposable paint tray liner device that provides users with a paint tray liner capable of preventing wet paint from staining the paint tray and requiring cleaning. There is also a long-felt need in the art for a disposable paint tray liner device that eliminates the need to constantly wash out the paint tray each time a user is finished painting walls, ceilings, and other surfaces. Further, there is a long-felt need in the art for a disposable paint tray liner device that includes an elastic band around the liner perimeter that fits snugly around the paint tray. Moreover, there is a long-felt need in the art for a device that allows users to simply throw away the liner once painting is finished, leaving behind a clean paint tray that can be used with a new liner. Further, there is a long-felt need in the art for a disposable paint tray liner device that provides an elastic band that is integrated into the liner perimeter. Finally, there is a long-felt need in the art for a disposable paint tray liner device that can be available in a box or kit.

The subject matter disclosed and claimed herein, in one embodiment thereof, comprises a disposable paint tray liner device. The device is a single use, plastic liner for paint trays. The disposable paint tray liner device comprises a body component that is a liner for a paint tray comprised of plastic material. The body component comprises an elastic band integrated around the body component perimeter. The elastic band can be used to secure the body component tightly to a paint tray. Users can fill the paint tray with paint while covered with the body component, preventing any paint from staining the paint tray itself. Once finished painting, the disposable paint tray liner device is removed and thrown away, leaving users with a clean paint tray.

In this manner, the disposable paint tray liner device of the present invention accomplishes all of the foregoing objectives and provides users with a device that protects paint trays from being stained with paint. The device is a transparent, plastic liner that easily secures to an interior of a paint tray. The device can be available in a box or a kit.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a disposable paint tray liner device. The disposable paint tray liner device comprises a body component comprised of plastic material. The body component comprises an elastic band integrated around the body component perimeter. The elastic band can be used to secure the body component tightly to a paint tray. Users can fill the paint tray with paint while covered with the body component, preventing any paint from staining the paint tray itself. Once finished painting, the disposable paint tray liner device is removed and thrown away, leaving users with a clean paint tray.

In one embodiment, the disposable paint tray liner device is shown for use with a paint tray. Typically, the paint tray has a well, an inclined portion, and four side walls. The side walls may have an outwardly facing lip. The disposable paint tray liner device is shaped to be slightly larger than the standard paint tray, so that the ends of the device extend over the side walls of the paint tray.

In one embodiment, the disposable paint tray liner device is a single use plastic liner for paint trays. Specifically, the disposable paint tray liner device comprises a body component. The body component is sized and shaped to cover the interior of a paint tray. As shown, the paint tray and the body component are generally rectangular in shape. However, the body component can be used with any conventional container or paint tray. Thus, the paint tray and the body component need not have four walls, but can have a single circular wall, or more than four walls. Accordingly, the body component need only to be slightly larger than the paint tray so that the body component can extend over the side wall(s) of the paint tray and removably engage the outer side walls of the paint tray.

In one embodiment, the body component of the device is a flexible sheet that is substantially impermeable to paint. Being a flexible sheet simplifies application of the body component into the paint tray. The body component simply requires it to be overlaid onto the interior surface of the paint tray and the flexible nature of the body component then allows the body component to naturally conform to the interior shape of the paint tray. The flexible nature of the body component further facilitates clean-up after use since the edges of the sheet-type body component can be gathered together to pool any leftover paint into the center of the body component and can simply be lifted out of the paint tray for disposal. Thus, after use, the body component is gathered up and removed from the paint tray and thrown away in the trash, leaving users with a clean paint tray.

In one embodiment, preferably, the entire body component extends over the side walls so that paint doesn't fall between the body component and the paint tray. However, the body component can be attached to the paint tray at a position that is interior to the paint tray. In addition, the entire body component need not extend over the side walls, but instead flaps or wings can be provided on the body component which are used to engage and secure the body component to the paint tray.

In one embodiment, the body component is formed from a unitary sheet of material. By forming the body component from a unitary sheet of material, the presence of seal lines within the body component are eliminated and pathways for leakage are reduced.

Preferably, the body component is made of polymeric materials. The polymeric materials selected for use in the present invention can include, but are not limited to, polyolefins, such as polypropylenes polyethylenes, polyvinyl chlorides, and mixtures thereof. Also, preferably, the polymeric materials for use herein are either clear or translucent, such that the user is able to visually see through the body component. Clarity can be enhanced by the use of clarifying agents during manufacture of the polymeric material. In other embodiments, the body component is not clear and manufactured in various colors.

In one embodiment, the body component is preferably engaged to the paint tray by an elastic band, and/or an adhesive member. Specifically, the body component has a closed channel which extends the entire perimeter of the body component and receives the elastic band. The channel can be any suitable shape and size, as long as it can retain the elastic band within it. The elastic band can be, for instance, an elongated rubber band or an elongated elastic band, or any other suitable stretchy band as is known in the art. Though the channel is shown as being a single channel, gaps can be provided in the channel at the corners so that the body component can be more easily fitted to the paint tray.

In another embodiment, the elastic band need not be a single member, but can be a plurality of elastic bands, each respectively coupled within a closed channel to the body component so as to cinch the body component around the paint tray. Thus, for instance, four elastic bands can be provided, one at each corner of the paint tray. It is important, however, that the elastic bands are not free from the body component, but instead be at least partially connected to the body component, such as being partially enclosed in the channels of the body component so that the elastic bands form a part of the body component for easy placement on, and removal from, the paint tray by the user.

In one embodiment, the elastic band is configured so that the body component can be sufficiently easy to fit over the lip of the side walls. The elastic band exerts sufficient force against the paint tray to engage the walls of the paint tray so that the body component does not inadvertently slip off of the paint tray during use. The elastic band is also configured so that it does not require excessive force or effort by the user to place the body component about the paint tray, or to remove the body component from the paint tray upon completion of the painting. The elastic band can also be retained by engaging the lip of the side wall.

In another embodiment, the disposable paint tray liner utilizes an adhesive member, such as a tape. The adhesive member is preferably fitted to the outer side of the body component, along the outer edge (or perimeter) of the body component. When the body component is placed in the paint tray, the edges of the body component extend over the side walls so that the adhesive member faces and secures to (or engages) the side wall of the paint tray.

In one embodiment, the adhesive member can be configured as a double-sided tape, with two adhesive layers, one of which is fixed to the body component edge. A cover strip is placed over the top of the other adhesive layer of the adhesive member. Once the body component is placed in the paint tray, the cover strip is removed to expose the adhesive layer of the adhesive member. The user then presses the adhesive layer against the paint tray so that it adheres to the outer portion of the side wall.

In another embodiment, the adhesive member need not extend the entire outer circumference of the body component. Rather, two or three adhesive members can be provided at each side wall of the paint tray. Each adhesive member can be provided with its own cover strip, or a single cover strip can be provided which covers all the adhesive members. The adhesive member need not be a double-sided tape, but instead can be an adhesive layer placed directly on the body component. The cover strip is placed over the adhesive layer, and removed when the user is ready to press the adhesive member against the paint tray.

In yet another embodiment, a closing strip is attached to the body component. The closing strip is preferably an elongated plastic strip having one end which is either integrally formed with the body component or attached to the body component. The other end of the closing strip is preferably secured to the body component, such as by an adhesive. Thus, the user can peel the closing strip so that one end becomes free from the body component when ready to be used. The closing strip can also be a thin metal twist tie, string, elastic band, or any other suitable device.

Once the body component is removed from the paint tray, the body component forms a bag which retains any unused paint. The closing strip is positioned on the body component so that it is at the top outer portion of the bag and can be wrapped around the body component to seal the bag. In another embodiment, more than one closing strip can be provided to further facilitate sealing of the bag.

In one embodiment, once the bag is lifted from the paint tray, the bag can be sealed with the closing strip and the paint stored in the bag. Alternatively, the bottom of the bag can be pierced, and the paint drained back into the paint can for storage. Toward that end, the body component can have an opening in the center of the body component which is sealed with a tape. When the paint is to be drained from the body component, the tape is removed to reveal the opening and allow the paint to be drained.

In one embodiment, the disposable paint tray liner device can be available in a box comprising multiple disposable paint tray liner devices of one size. In another embodiment, the disposable paint tray liner device can be packaged as a kit including disposable paint tray liner devices in different sizes, as well as multiple paint trays and/or paint rollers and roller pads.

In yet another embodiment, the disposable paint tray liner device comprises a plurality of indicia.

In yet another embodiment, a method of easily cleaning a paint tray after use via using a paint tray liner is disclosed. The method includes the steps of providing a disposable paint tray liner device comprising a body component with an elastic band integrated around the perimeter. The method also comprises inserting the body component into an interior of a paint tray. Further, the method comprises securing the body component on the paint tray via the elastic band. The method comprises pouring paint into the paint tray. The method also comprises rolling the paint within the paint tray to paint a room, a ceiling, a door, etc. The method comprises, once finished painting, removing the disposable paint tray liner device from the paint tray along with any remaining paint. Finally, the method comprises disposing of the used disposable paint tray liner device in the garbage.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the disposable paint tray liner device of the present invention in use in accordance with the disclosed architecture;

FIG. 2 illustrates a perspective view of one embodiment of the disposable paint tray liner device of the present invention showing how the device is applied to the paint tray in accordance with the disclosed architecture;

FIG. 3 illustrates a perspective view of one embodiment of the disposable paint tray liner device of the present invention showing how the elastic band secures the device to the paint tray in accordance with the disclosed architecture;

FIG. 4 illustrates a perspective view of one embodiment of the disposable paint tray liner device of the present invention showing how the device prevents wet paint from straining the paint tray in accordance with the disclosed architecture;

FIG. 5 illustrates a perspective view of one embodiment of the disposable paint tray liner device of the present invention showing how the device can be disposed after use in accordance with the disclosed architecture; and

FIG. 6 illustrates a flowchart showing the method of easily cleaning a paint tray after use via using a paint tray liner in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a disposable paint tray liner device that provides users with a paint tray liner capable of preventing wet paint from staining the paint tray and requiring cleaning. There is also a long-felt need in the art for a disposable paint tray liner device that eliminates the need to constantly wash out the paint tray each time a user is finished painting walls, ceilings, and other surfaces. Further, there is a long-felt need in the art for a disposable paint tray liner device that includes an elastic band around the liner perimeter that fits snugly around the paint tray. Moreover, there is a long-felt need in the art for a device that allows users to simply throw away the liner once painting is finished, leaving behind a clean paint tray that can be used with a new liner. Further, there is a long-felt need in the art for a disposable paint tray liner device that provides an elastic band that is integrated into the liner perimeter. Finally, there is a long-felt need in the art for a disposable paint tray liner device that can be available in a box or kit.

The present invention, in one exemplary embodiment, is a novel disposable paint tray liner device. The disposable paint tray liner device comprises a body component comprised of plastic material. The body component comprises an elastic band integrated around the body component perimeter. The elastic band can be used to secure the body component tightly to a paint tray. Users can fill the paint tray with paint while covered with the body component, preventing any paint from staining the paint tray itself. Once finished painting, the disposable paint tray liner device is removed and thrown away, leaving users with a clean paint tray. The present invention also includes a novel method of easily cleaning a paint tray after use via using a paint tray liner. The method includes the steps of providing a disposable paint tray liner device comprising a body component with an elastic band integrated around the perimeter. The method also comprises inserting the body component into an interior of a paint tray. Further, the method comprises securing the body component on the paint tray via the elastic band. The method comprises pouring paint into the paint tray. The method also comprises rolling the paint within the paint tray to paint a room, a ceiling, a door, etc. The method comprises, once finished painting, removing the disposable paint tray liner device from the paint tray along with any remaining paint. Finally, the method comprises disposing of the used disposable paint tray liner device in the garbage.

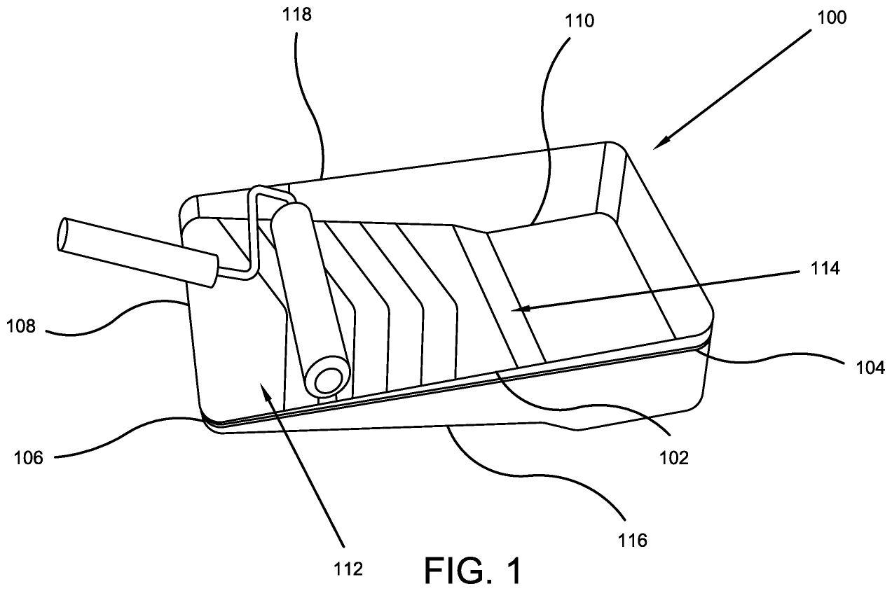

Referring initially to the drawings, FIG. 1 illustrates a perspective view of one embodiment of the disposable paint tray liner device 100 of the present invention. In the present embodiment, the disposable paint tray liner device 100 is an improved disposable paint tray liner device 100 that provides a user with a single use plastic liner for a paint tray 106. Specifically, the disposable paint tray liner device 100 comprises a body component 102 with an elastic band 104 integrated around a perimeter 108 of the body component 102. The elastic band 104 can be used to secure the body component 102 tightly to a paint tray 106. Users can fill the paint tray 106 with paint 110 while it is covered with the body component 102, preventing any paint 110 from staining the paint tray 106 itself. Once finished painting, the disposable paint tray liner device 100 is removed and thrown away, leaving users with a clean paint tray 106.

Generally, the disposable paint tray liner device 100 is shown for use with a conventional paint tray 106. Typically, the paint tray 106 has a well 112, an inclined portion 114, and four side walls 116. The side walls 116 may have an outwardly facing lip 118. The disposable paint tray liner device 100 is shaped to be slightly larger than the standard paint tray 106, so that the ends (i.e., perimeter 108) of the device 100 extend over the side walls 116 of the paint tray 106.

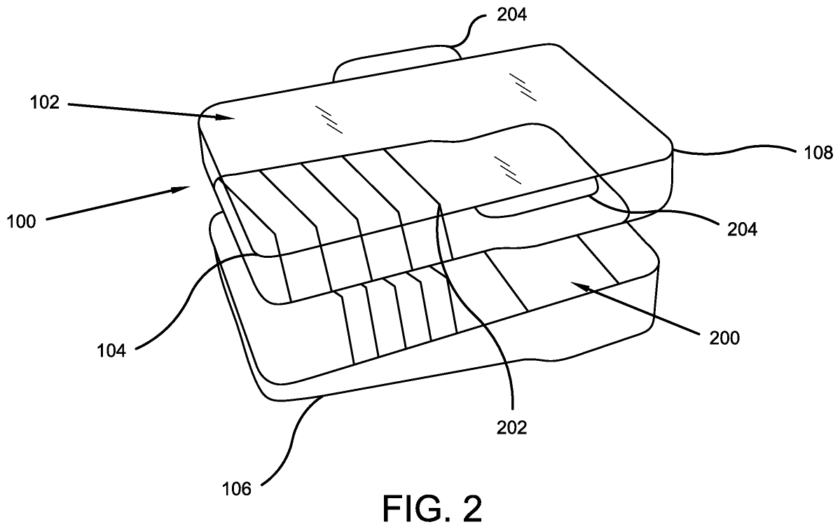

As shown in FIG. 2, the disposable paint tray liner device 100 is a single use plastic liner for paint trays 106. Specifically, the disposable paint tray liner device 100 comprises a body component 102. The body component 102 is sized and shaped to cover the interior 200 of a paint tray 106. As shown, the paint tray 106 and the body component 102 are generally rectangular in shape. However, the body component 102 can be used with any conventional container or paint tray 106. Thus, the paint tray 106 and the body component 102 need not have four walls 116, but can have a single circular wall, or more than four walls. Accordingly, the body component 102 need only be slightly larger than the paint tray 106 so that the body component 102 can extend over the side wall(s) 116 of the paint tray 106 and removably engage the outer side walls 116 of the paint tray 106.

Generally, the body component 102 of the device 100 is a flexible sheet that is substantially impermeable to paint 110. Being a flexible sheet simplifies application of the body component 102 into the paint tray 106. The body component 102 simply requires it to be overlaid onto the interior surface 200 of the paint tray 106 and the flexible nature of the body component 102 then allows the body component 102 to naturally conform to the interior shape of the paint tray 106. The flexible nature of the body component 102 further facilitates clean-up after use since the edges 108 of the sheet-type body component 102 can be gathered together to pool any leftover paint 110 into the center 202 of the body component 102 and can simply be lifted out of the paint tray 106 for disposal. Thus, after use, the body component 102 is gathered up and removed from the paint tray 106 and thrown away in the trash, leaving users with a clean paint tray 106.

Preferably, the entire body component 102 extends over the side walls 116 so that paint 110 does not fall between the body component 102 and the paint tray 106. However, the body component 102 can be attached to the paint tray 106 at a position interior to the paint tray 106. In addition, the entire body component 102 need not extend over the side walls 116, but instead, flaps or wings 204 can be provided on the body component 102 which are used to engage and secure the body component 102 to the paint tray 106. The flaps or wings 204 can be any suitable size as is known in the art, as long as they act to secure the body component 102 within the paint tray 106.

In one embodiment, the body component 102 is formed from a unitary sheet of material. By forming the body component 102 from a unitary sheet of material, the presence of seal lines within the body component 102 are eliminated and pathways for leakage are reduced. However, the body component 102 can be formed from multiple sheets of material sealed together, as well, depending on the needs and/or wants of a user.

Preferably, the body component 102 is made of polymeric materials. The polymeric materials selected for use in the present invention can include, but are not limited to, polyolefins, such as polypropylenes polyethylenes, polyvinyl chlorides, and mixtures thereof. Also, preferably, the polymeric materials for use herein are either clear or translucent, such that the user is able to visually see through the body component 102. Clarity can be enhanced by the use of clarifying agents during manufacture of the polymeric material. In other embodiments, the body component 102 is not clear and manufactured in various colors, depending on the needs and/or wants of a user.

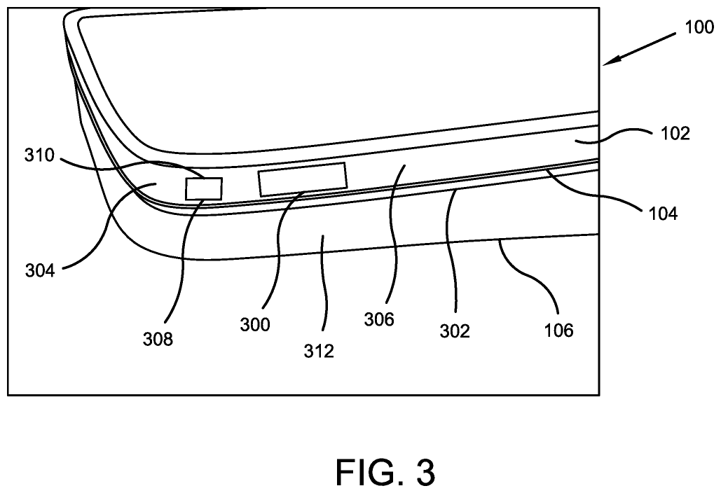

As shown in FIG. 3, the body component 102 is preferably engaged to the paint tray 106 by an elastic band 104, and/or an adhesive member 300. Specifically, the body component 102 has a closed channel 302 which extends the entire perimeter 108 of the body component 102 and receives the elastic band 104. The channel 302 can be any suitable shape and size, as long as it can retain the elastic band 104 within it. The elastic band 104 can be, for instance, an elongated rubber band or an elongated elastic band, or any other suitable stretchy band as is known in the art. Though the channel 302 is shown as being a single channel, gaps can be provided in the channel 302 at the corners 304 so that the body component 102 can be more easily fitted to the paint tray 106.

In another embodiment, the elastic band 104 need not be a single member, but can be a plurality of elastic bands, each respectively coupled within a closed channel 302 to the body component 102 so as to cinch the body component 102 around the paint tray 106. Thus, for instance, four elastic bands 104 can be provided, one at each corner 304 of the body component 102. It is important, however, that the elastic bands 104 are not free from the body component 102, but instead be at least partially connected to the body component 102, such as being partially enclosed in the channels 302 of the body component 102 so that the elastic bands 104 form a part of the body component 102 for easy placement on, and removal from, the paint tray 106 by the user.

Furthermore, the elastic band 104 is configured so that the body component 102 can be sufficiently easy to fit over the lip 118 of the side walls 116. The elastic band 104 exerts sufficient force against the paint tray 106 to engage the walls 116 of the paint tray 106 so that the body component 102 does not inadvertently slip off of the paint tray 106 during use. The elastic band 104 is also configured so that it does not require excessive force or effort by the user to place the body component 102 about the paint tray 106, or to remove the body component 102 from the paint tray 106 upon completion of the painting. The elastic band 104 can also be retained by engaging the lip 118 of the side wall 116.

In another embodiment, the disposable paint tray liner device 100 utilizes an adhesive member 300, such as a tape. The adhesive member 300 is preferably fitted to the outer side 306 of the body component 102, along the outer edge (or perimeter 108) of the body component 102. When the body component 102 is placed in the paint tray 106, the edges 108 of the body component 102 extend over the side walls 116 so that the adhesive member 300 faces and secures to (or engages) the side wall 116 of the paint tray 106.

In one embodiment, the adhesive member 300 can be configured as a double-sided tape 308, with two adhesive layers, one of which is fixed to the body component edge 108. A cover strip 310 is placed over the top of the other adhesive layer of the adhesive member (i.e., double-sided tape 308). Once the body component 102 is placed in the paint tray 106, the cover strip 310 is removed to expose the adhesive layer of the adhesive member (i.e., double-sided tape 308). The user then presses the adhesive layer against the paint tray 106 so that it adheres to the outer portion 312 of the side wall 116.

Furthermore, the adhesive member 300 need not extend the entire outer perimeter 108 of the body component 102. Rather, two or three adhesive members 300 can be provided at each side wall 116 of the paint tray 106. Each adhesive member 300 can be provided with its own cover strip 310, or a single cover strip 310 can be provided which covers all the adhesive members 300. The adhesive member 300 need not be a double-sided tape 308, but instead can be an adhesive layer placed directly on the body component 102. The cover strip 310 is placed over the adhesive layer, and removed when the user is ready to press the adhesive member 300 against the paint tray 106.

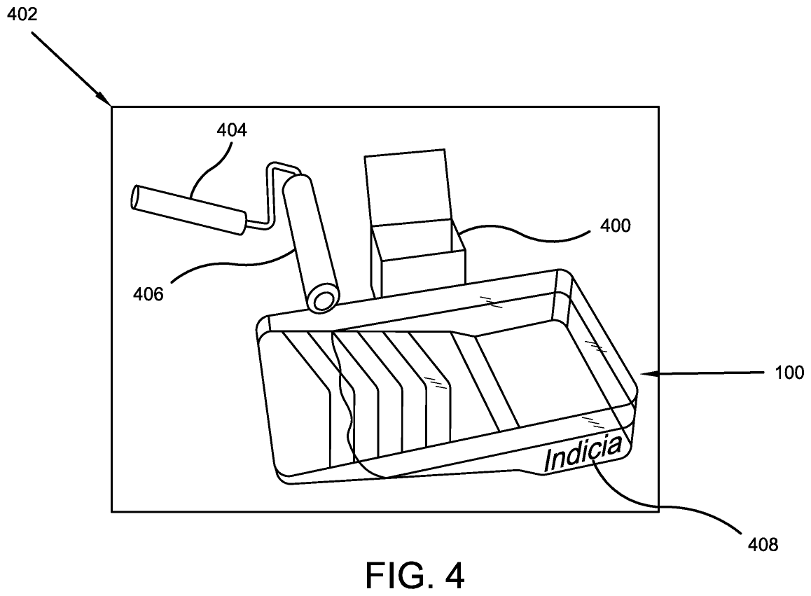

As shown in FIG. 4, the disposable paint tray liner device 100 can be available in a box 400 comprising multiple disposable paint tray liner devices 100 of one size. In another embodiment, the disposable paint tray liner device 100 can be packaged as a kit 402 including disposable paint tray liner devices 100 in different sizes, as well as multiple paint trays 106 and/or paint rollers 404 and roller pads 406.

In yet another embodiment, the disposable paint tray liner device 100 comprises a plurality of indicia 408. The body component 102 of the device 100 may include advertising, trademark, other letters, designs, or characters, printed, painted, stamped, or integrated into the body component 102, or any other indicia 408 as is known in the art. Specifically, any suitable indicia 408 as is known in the art can be included, such as, but not limited to, patterns, logos, emblems, images, symbols, designs, letters, words, characters, animals, advertisements, brands, etc., that may or may not be paint, paint tray, or brand related.

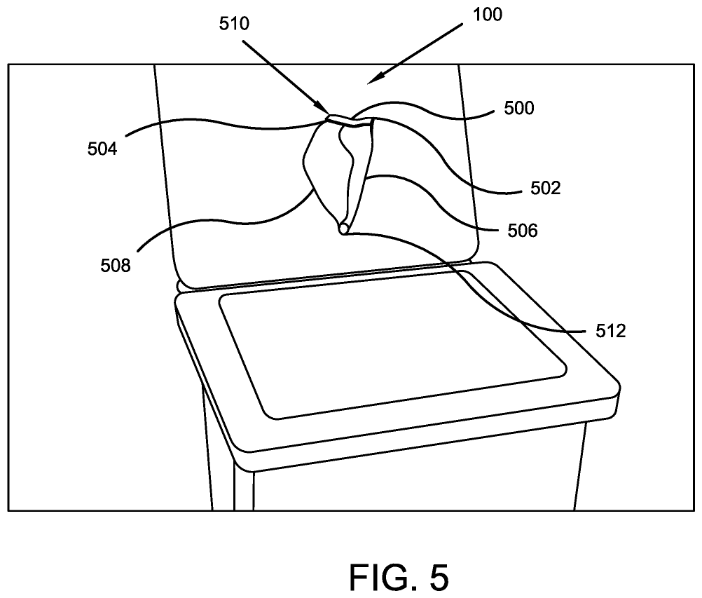

As shown in FIG. 5, a closing strip 500 is attached to the body component 102. The closing strip 500 is preferably an elongated plastic strip having one end 502 which is either integrally formed with the body component 102 or attached to the body component 102. The other end 504 of the closing strip 500 is preferably secured to the body component 102, such as by an adhesive. Thus, the user can peel the closing strip 500 so that one end 504 becomes free from the body component 102, when ready to be used. The closing strip 500 can also be a thin metal twist tie, string, elastic band, or any other suitable device as is known in the art.

Furthermore, once the body component 102 is removed from the paint tray 106, the body component 102 forms a bag 508 which retains any unused paint 110. The closing strip 500 is positioned on the body component 102 so that it is at the top outer portion 510 of the bag 508 and can be wrapped around the body component 102 to seal the bag 508. In another embodiment, more than one closing strip 500 can be provided to further facilitate sealing of the bag 508. In yet another embodiment, the bag 508 can be sealed by twisting the top outer portion 510 together and tying it in a knot or just throwing it away, without further securing the bag 508.

Accordingly, once the bag 508 is lifted from the paint tray 106, the bag 508 can be sealed with the closing strip 500 and the paint 110 stored in the bag. Alternatively, the bottom 512 of the bag 508 can be pierced, and the paint 110 drained back into the paint can for storage. Toward that end, the body component 102 can have an opening 506 in the center 202 of the body component 102 which is sealed with a tape or other adhesive member 300. When the paint 110 is to be drained from the body component 102, the tape 300 is removed to reveal the opening 506 and allow the paint 110 to be drained.

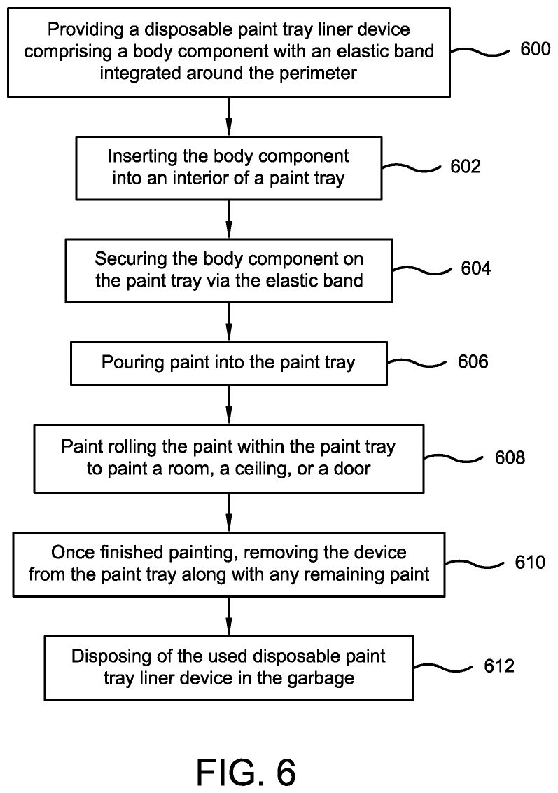

FIG. 6 illustrates a flowchart of the method of easily cleaning a paint tray after use via using a paint tray liner. The method includes the steps of at 600, providing a disposable paint tray liner device comprising a body component with an elastic band integrated around the perimeter. The method also comprises at 602, inserting the body component into an interior of a paint tray. Further, the method comprises at 604, securing the body component on the paint tray via the elastic band. The method comprises at 606, pouring paint into the paint tray. The method also comprises at 608, rolling the paint within the paint tray to paint a room, a ceiling, a door, etc. The method comprises at 610, once finished painting, removing the disposable paint tray liner device from the paint tray along with any remaining paint. Finally, the method comprises at 612, disposing of the used disposable paint tray liner device in the garbage.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “disposable paint tray liner device”, “disposable paint tray device”, “liner device”, “paint tray liner device”, and “device” are interchangeable and refer to the disposable paint tray liner device 100 of the present invention.

Notwithstanding the foregoing, the disposable paint tray liner device 100 of the present invention can be of any suitable size and configuration as is known in the art without affecting the overall concept of the invention, provided that it accomplishes the above-stated objectives. One of ordinary skill in the art will appreciate that the disposable paint tray liner device 100 as shown in FIGS. 1-6 are for illustrative purposes only, and that many other sizes and shapes of the disposable paint tray liner device 100 are well within the scope of the present disclosure. Although the dimensions of the disposable paint tray liner device 100 are important design parameters for user convenience, the disposable paint tray liner device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A disposable paint tray liner device that provides a user with a single use plastic liner for a paint tray, the disposable paint tray liner comprising:
a body component; and
an elastic band;
wherein the elastic band is integrated around a perimeter of the body component;
wherein the body component is secured to an interior of a paint tray via the elastic band;
wherein a user fills the paint tray with paint while covered with the body component; and
further wherein after painting, the body component is removed and thrown away, leaving a clean paint tray.

2. The disposable paint tray liner device of claim 1, wherein the paint tray has a well, an inclined portion, and four side walls with an outwardly facing lip.

3. The disposable paint tray liner device of claim 2, wherein the body component is shaped to be slightly larger than the paint tray, so that a perimeter of the body component extends over the four side walls of the paint tray and removably engage outer side walls of the paint tray.

4. The disposable paint tray liner device of claim 3, wherein the body component is rectangular in shape and is sized to cover an interior of the paint tray.

5. The disposable paint tray liner device of claim 4, wherein the body component is a flexible sheet that is substantially impermeable to paint.

6. The disposable paint tray liner device of claim 5, wherein the body component naturally conforms to an interior shape of the paint tray when applied.

7. The disposable paint tray liner device of claim 6, wherein the body component is gathered together to pool any leftover paint into center of the body component and simply lifted out of the paint tray for disposal.

8. The disposable paint tray liner device of claim 7, wherein the body component comprises flaps that extend over the four side walls for engaging and securing the body component to the paint tray.

9. The disposable paint tray liner device of claim 8, wherein the body component has a closed channel which extends around entire perimeter of the body component and receives the elastic band.

10. The disposable paint tray liner device of claim 9, wherein there are a plurality of elastic bands, each respectively coupled within a closed channel to the body component, so as to cinch the body component around the paint tray.

11. The disposable paint tray liner device of claim 1, wherein the body component utilizes an adhesive member, such as a tape instead of the elastic band.

12. The disposable paint tray liner device of claim 11, wherein the adhesive member is a double-sided tape which adheres the body component to an outer portion of the four side walls.

13. The disposable paint tray liner device of claim 1, wherein the disposable paint tray liner device is available in a box comprising multiple disposable paint tray liner devices of one size.

14. The disposable paint tray liner device of claim 1, wherein the disposable paint tray liner device is packaged as a kit including disposable paint tray liner devices in different sizes, as well as multiple paint trays and paint rollers and roller pads.

15. A disposable paint tray liner device that provides a user with a single use plastic liner for a paint tray, the disposable paint tray liner comprising:
a body component; and
an elastic band;
wherein the elastic band is integrated around a perimeter of the body component;
wherein the body component has a closed channel which extends around entire perimeter of the body component and receives the elastic band;
wherein the body component is secured to an interior of a paint tray via the elastic band;
wherein a user fills the paint tray with paint while covered with the body component;
wherein after painting, the body component is removed and thrown away, leaving a clean paint tray;
wherein once the body component is removed from the paint tray, the body component forms a bag which retains any unused paint; and
further wherein a closing strip is positioned on the body component, at a top outer portion of the bag and is wrapped around the body component to seal the bag.

16. The disposable paint tray liner device of claim 15 further comprising a plurality of indicia.

17. The disposable paint tray liner device of claim 15, wherein once the bag is lifted from the paint tray, the bag is sealed with the closing strip and the unused paint is stored in the bag.

18. The disposable paint tray liner device of claim 15, wherein a bottom of the bag can be pierced, and the unused paint is drained back into a paint can for storage.

19. The disposable paint tray liner device of claim 15, wherein the body component comprises an opening in a center of the body component which is sealed with a tape, and when the unused paint is to be drained from the body component, the tape is removed to reveal the opening and allow the unused paint to be drained.

20. A method of easily cleaning a paint tray after use via using a paint tray liner, the method comprising the following steps:
providing a disposable paint tray liner device comprising a body component with an elastic band integrated around the perimeter;
inserting the body component into an interior of a paint tray;
securing the body component on the paint tray via the elastic band;
pouring paint into the paint tray;
paint rolling the paint within the paint tray to paint a room, a ceiling, or a door;
once finished painting, removing the disposable paint tray liner device from the paint tray along with any remaining paint; and
disposing of the used disposable paint tray liner device in the garbage.
